(19) United States
(12) Patent Application Publication
(10) Pub. No.: US 2008/0061242 A1
(43) Pub. Date: Mar. 13, 2008

(54) Multi-modality imaging systems in radical medicine and methods of using the same

(76) Inventors: A. Hans Vija, Evanston, IL (US); Eric G. Hawman, Schaumburg, IL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/520,119

(22) Filed: Sep. 13, 2006

(51) Int. Cl. G01T 1/161; H05G 1/02; G01T 1/164

(52) U.S. Cl. 250/363.08; 378/193

(57) ABSTRACT

A radical imaging system for use in radical medicine using a movable pallet for moving the patient during radical imaging. With the movable pallet, the patient can be moved, such as rotated to a position such that signal attenuation and scattering can be decreased. The imaging system may also incorporate a collimator with finite focal length, or a collimator whose focal length and/or spatial resolution can be adjusted dynamically.

### CROSS-REFERENCE TO RELATED PUBLICATIONS

Subject matter of each one of the following publications is incorporated herein by reference in entirety:

1) “Tomographic Gamma-Ray Scanner with Simultaneous Readout of Several Planes” by H. O. Anger, Fundamental Problems in Scanning, Eds. A. Gottschalk and R. N. Beck, Charles C. Thomas Pub., Springfield, Ill. (1969), Chap. 14, pp 195-211;

2) Pho/Con-192 Emission Tomographyic Imaging System, Model 1794, Siemens Medical Systems (product brochure) circa 1982; and

3) “Iterative deblurring algorithm for a multiplane tomographic scanner” by A. Zenari, R. H. Hooper, N Osborne, and J. W. Scrimger, Phys. Med. Biol., 30:7, 657-668 (1985).

### TECHNICAL FIELD OF THE INVENTION

The present invention relates to the art of radical medicine, and more particularly to the art of multi-modality radical imaging systems and methods of using the same.

### BACKGROUND OF THE INVENTION

Radical medicine plays a significantly important role in medical diagnosis and therapy. In radical medicine, radiation, such as x-ray beams, electrons, positrons, ultrasonic phonons, fluorescent photons, and gamma-rays, is used as interactive or non-interactive probes to obtain images that carry functional and/or anatomic information of target objects, such as organs, bones, and tissues of human body. Using different radiation probes, a variety of radical imaging systems for use in radical medicine are produced, such as positron emission tomography (PET), single photon emission computed tomography (SPECT), ultrasound, magnetic resonance imaging (MRI), computed tomography (CT), static x-ray imaging, and dynamic (fluoroscopy) x-ray imaging.

Nuclear medicine is a sub-field of radical medicine, which uses probes (e.g., gamma photons) generated by nuclei in imaging. In nuclear imaging, a patient is injected with or swallows a radioactive isotope which has an affinity for a particular organ, structure, or tissue of human body. In single photon nuclear imaging, either planar or tomographic (SPECT), gamma rays are emitted from the body part of interest and detected by a gamma camera apparatus, which forms an image of the organ based on the detected concentration and distribution of the radioactive isotope within the body part of interest.

Nuclear imaging is particularly suited to studying function of the tissue and organs, such as cardiac function or blood flow through the brain, while other imaging modalities such as CT and MRI are more anatomically-oriented. Consequently, it would be particularly useful in oncological (e.g., tumor) studies to use SPECT or PET imaging to detect lesions, and to align or register the nuclear image with a medical image from another modality such as CT or MRI, which offers better anatomical information. A system incorporating different imaging techniques is often referred to as multi-modality imaging system, such as SPECT and CT (hereafter SPECT/CT) and PET and CT (hereafter PET/CT). The fused image would enable the clinician to determine the anatomical position of a lesion displayed by the nuclear image more accurately, and the organs and structures affected to be ascertained with higher accuracy and confidence.

Current multi-modality imaging systems used in radical medicine, especially SPECT/CT, have many limitations. For example, current instrumentation for imaging of the prostate is limited by long imaging time (e.g. approximately 50 minutes or even more) and poor spatial resolution (e.g. approximately 2 cm). It is often difficult to determine whether prostate cancer of the patient being examined has spread beyond the prostate gland into the seminal vesicles or adjacent lymph nodes. An imaging system capable of imaging the prostate (and/or other small organs) and adjacent areas with high speed and/or spatial resolution is strongly desired. It is also desired that fused images can be used in real-time in guiding therapy, which is not available in current multi-modality imaging systems because unfettered access, such as unfettered access to crotch areas for prostate therapy, is almost impossible shortly after or during imaging processes.

### SUMMARY OF THE INVENTION

The objects and advantages of the present invention will be become more fully understood from the detailed description provided hereafter, and are accomplished by the present invention that provides a multi-modality radical imaging system for use in radical medicine.

As an example of the invention, a radical imaging system for use in radical medicine comprises a radiation source for emitting radiation rays; a camera for detecting the radiation rays; a movable supporting mechanism on which a patient can be held; a stationary supporting mechanism for supporting and holding the movable first supporting mechanism; and wherein the movable supporting mechanism is capable of rotating relative to the stationary supporting mechanism along a pivoting point located within the movable supporting mechanism.

As another example of the invention, a method for examining a patient comprises placing the patient on a patient table and aligning the patient with a first examination axis; imaging the patient with a radical imaging system; aligning the patient with a second examination axis that is at an angle of at least 45 degrees (e.g. substantially perpendicular) to the first examination axis; and imaging the patient with the radiation imaging system.

As yet another example of the invention, a radical examining system for use in radical medicine comprises a radical source generating radical ray; a camera optically coupled to the radical source for detecting the radical ray from the radical source; a patient table on which a patient can be placed; a collimator comprising a set of structures that together define a non-infinite focal point; and a driving mechanism coupled to the collimator, patient table, or the camera for causing the focal point of the collimator to move relative to the patient table.

As still yet another example of the invention, a method comprises placing a patient in a radical imaging system; and imaging a field of the patient using the radical system and acting on the field based on the image substantially simultaneously with imaging.

As yet another example of the invention, a radical image for use in radical medicine comprises a radical source generating a beam of radiation ray; a camera for generating an image using the radiation beam; and a collimator composed of a stack of movable slats.

As yet another example of the invention, an imaging method comprises aligning a radical source, target object, and camera such that a radiation beam from the radical source is capable of being detected by the camera after passing through the target object; placing a collimator between the target object and camera, wherein said collimator comprises a stack of movable slats; adjusting the slats such that the collimator has a non-infinite focal point; and imaging the target object by scanning the focal point on the target object.

As yet another example of the invention, an imaging method using a radical imaging system comprises turning the patient on a movable support; and moving a detector between the legs of the patient in order to perform a screen, wherein the detector detects radiation for generating images.

Such objects of the invention are achieved in the features of the independent claims attached hereto. Preferred embodiments are characterized in the dependent claims. In the claims, only elements denoted by the words “means for” are intended to be interpreted as means plus function claims under 35 U.S.C. § 112, the sixth paragraph.

### BRIEF DESCRIPTION OF DRAWINGS

While the appended claims set forth the features of the present invention with particularity, the invention, together with its objects and advantages, may be best understood from the following detailed description taken in conjunction with the accompanying drawings of which:

FIG. 1 is a top view of a portion of an exemplary nuclear imaging system for use in radical medicine according to an example of the invention;

FIG. 2 is a top view of the system in FIG. 1 with the pallet being rotated to an angle so as to enable real-time therapy during or shortly after the imaging process;

FIG. 3 is a perspective view of FIG. 2 demonstratively illustrating the imaging position and intervention position of the pallet;

FIG. 4 is a cross-view of the imaging assembly of FIG. 3;

FIG. 5 demonstratively illustrates a top view of relative position of the image detector and the organ being examined;

FIG. 6 is an exemplary configuration of the pallet used in the radical imaging system according to an example of the invention;

FIG. 7 is another exemplary configuration of the pallet used in the radical imaging system according to an example of the invention; and

FIG. 8 is a diagram showing an exemplary SPECT setup for prostate brachytherapy according to an example of the invention.

### DETAILED DESCRIPTION OF EXEMPLARY EMBODIMENTS

This invention provides a multi-modality imaging system for use in radical medicine and methods of using the same. In the following, the invention will be discussed in connection with various embodiments. In view of the many possible embodiments to which the principles of this invention may be applied, it should be recognized that the embodiments described herein in connection with the drawings are meant to be illustrative only and should not be taken as limiting the scope of invention. Those skilled in the art will recognize that the illustrated embodiments can be modified in arrangement and detail without departing from the spirit of the invention. The embodiments that will be discussed herein are not mutually exclusive, unless so stated, or if readily apparent to those of ordinary skill in the art.

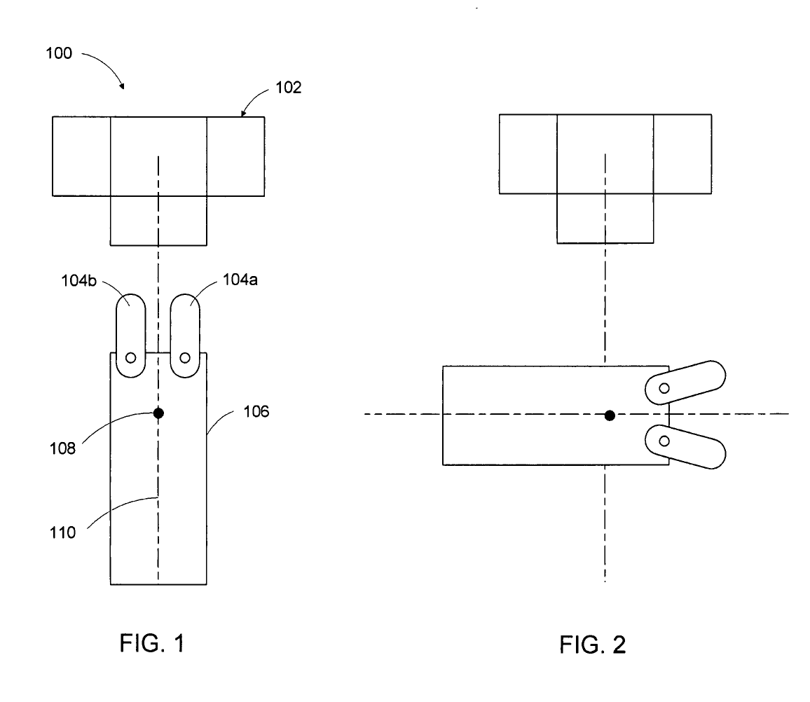

Referring to the drawings, FIG. 1 is a top view of a portion of an exemplary nuclear imaging system for use in radical medicine according to an example of the invention. In its basic configuration, image system 100 comprises imaging assembly 102 and patient pallet 106. As an alternative feature, foot rests 104a and 104b can be attached to the pallet for holding feet of the patient.

Imaging assembly 102 of this example can be SPECT, PET, SPECT/CT, or PET/CT, or other nuclear imaging instruments used in radical medicine. Patient pallet 106 is provided for supporting a patient undergoing imaging. In operation, the pallet is aligned to imaging axis 110 of the imaging assembly. Such position of the pallet is referred to as the imaging position.

For enabling real-time therapy, such as prostate brachytherapy during or shortly after the imaging process, the pallet is constructed such that the pallet is movable, especially rotatable about a rotational axis that is preferably perpendicular to the pallet. As shown in the figure, the rotation axis passes through pivoting point 108 and normal to the imaging axis 110. The pivoting point can be stationary or movable when the pallet is moving. It is preferred that the pivoting point is within the pallet, but not required. The rotated position is referred to as an intervention position, which is shown in FIG. 2.

Referring to FIG. 2, in the intervention position, pallet 106 is rotated 90 degrees relative to the imaging position as shown in FIG. 1. In other instances when necessary, the pallet can be rotated to any desired angle. At the intervention position wherein the pallet, with the patient thereon, is rotated 90 degrees, the detector (e.g. gamma camera) of the imaging assembly can be placed close to the field of interest. For example, the detector can be placed substantially at the same plane of the prostate of the patient's body such that the detector can be as close as possible to the prostate of the patient's body. In this way, unfettered access to the crotch area required for prostate brachytherapy is made available during or shortly after the imaging process. Moreover, signal attenuation and/or scattering, such as from the pelvis when prostate is being examined, can be depressed.

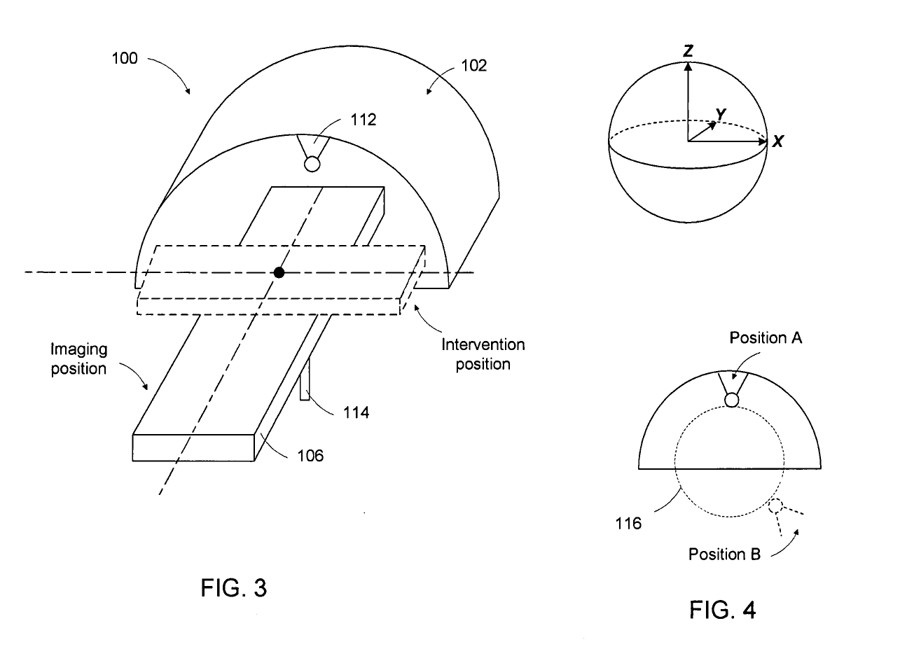

FIG. 3 illustrates a perspective view of the imaging system as shown in FIG. 1 and FIG. 2. Referring to FIG. 3, pallet 106 (e.g. a prostate pallet) is attached to and supported by supporting mechanism 114 such that the pallet can rotate about a rotation axis that passes through the pivoting point (represented by the dark circle). Detector 112 (e.g., gamma camera) is attached to and held by detector housing 102 that defines a bore in which the patient can be disposed. It is preferred that the detector is movable along a pre-determined path, such as a circular orbit, in the housing. As shown in the inset FIG. 4, the pallet is located in the X-Y plane; and is rotatable in the X-Y plane. The camera can be located in, and thus rotate within the X-Z (or Y-Z) plane. It is noted that the camera may or may not rotate at the spherical surface—that is, the path of the camera may or may not be circular.

FIG. 4 demonstratively illustrates rotation of the detector in an imaging process. In the imaging process, the pallet is positioned at the imaging position (Position A) wherein the pallet is aligned to the imaging axis as shown. In the intervention process, the pallet can be rotated (but not necessarily) to the intervention position (Position B) wherein the pallet is rotated to an angle, such as at least 45 degrees (e.g. around 90 degrees) from the imaging position.

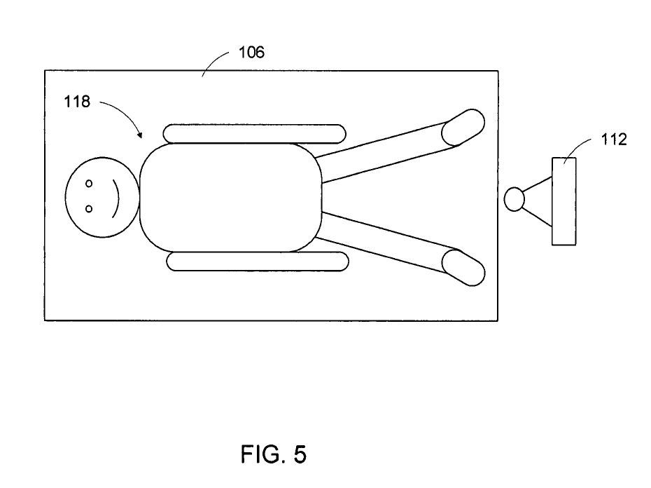

In the intervention process (or imaging process), the pallet is rotated to an angle such that the detector can be placed as close to the organ of interest as possible, which is better illustrated in a top view of the system in FIG. 5. Referring to FIG. 5, patient 118 is disposed on pallet 106. At this intervention position, the patient can open his/her legs so as to dispose the prostate as closely as possible to detector 112 for generating high quality radical images by avoiding potential signal attenuation and/or scattering from the pelvis of the patient.

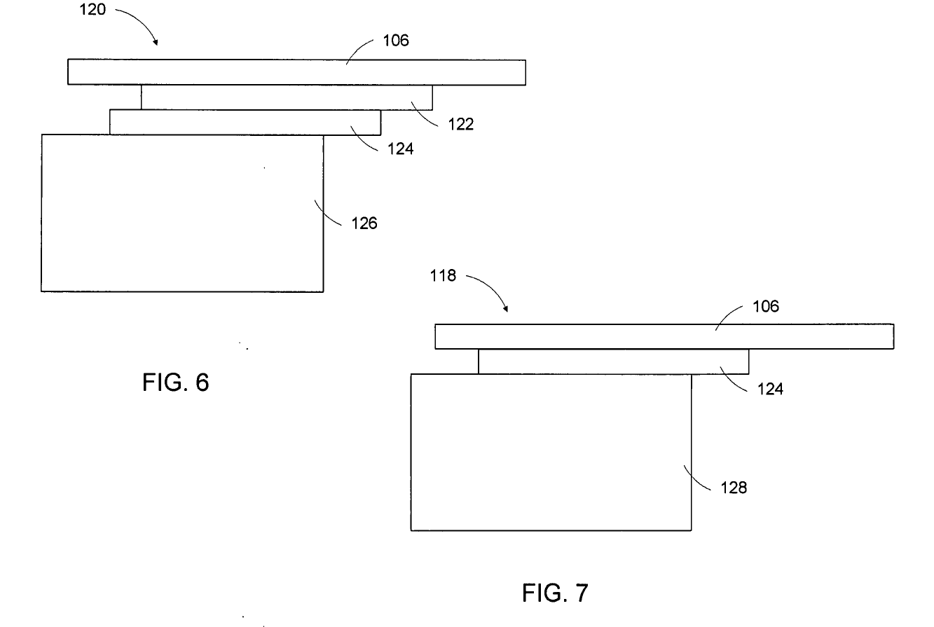

The rotatable pallet in the radical imaging system as discussed above can be configured in many ways, examples of which are demonstratively illustrated in FIG. 6 and FIG. 7. Referring to FIG. 6, the rotatable pallet can be an add-on to existing pallet design, such as the Symbia® PHS, for example. Specifically, rotatable pallet 106 can be attached to pallet 122 on index plate 124. The index plate is mounted on Symbia® PHS 126, for example. Not shown in the figure can be a rotating and supporting mechanism coupling rotatable pallet 106 to one or more stationary structures, such as index plate 124, plate 122, and PHS 126, of the system so as to facilitate rotation of the rotatable pallet.

An alternative configuration of the rotatable pallet is illustrated in FIG. 7. As shown in FIG. 7, rotatable pallet 106 of an aspect of the invention can be directly attached to the index plate, such as the Symbia® PHS index plate 124, for example, of the imaging system. Of course, other alternative configurations with rotatable pallet are also applicable.

Nuclear Imaging Systems with Converging Collimators

Current nuclear imaging systems for use in nuclear medicine, such as nuclear imaging systems for prostates, are limited by long imaging time and poor spatial resolution. It is often difficult to determine, for example, whether prostate cancer has spread beyond the prostate gland into the seminal vesicles, or vicinity lymph nodes. A solution to this problem is provided herein according to a further aspect of the invention.

The radical imaging system according to an example of the invention employs modern iterative reconstruction (e.g. maximum likelihood with 3D-beam modeling) techniques that have the capability of correcting depth dependent resolution and attenuation. A large Filed-of-View (hereafter FOV) short focal length cone beam collimator is used for taking images. The collimator can be constructed such that the collimator is movable relative to the patient (or the FOV) or the camera. Moreover, the collimator can be constructed with structures that are dynamically movable during imaging. By adjusting the structures of the collimator, focal length and spatial resolution of the collimator can be dynamically adjusted when necessary. The system thus can be of great importance for detecting prostate cancer and for brachytherapy treatment of prostate cancer because the radioactive seed is enabled to be localized with CT, and images obtained therefrom can be fused with SPECT so as to correlate density of seed placement with active tumor regions.

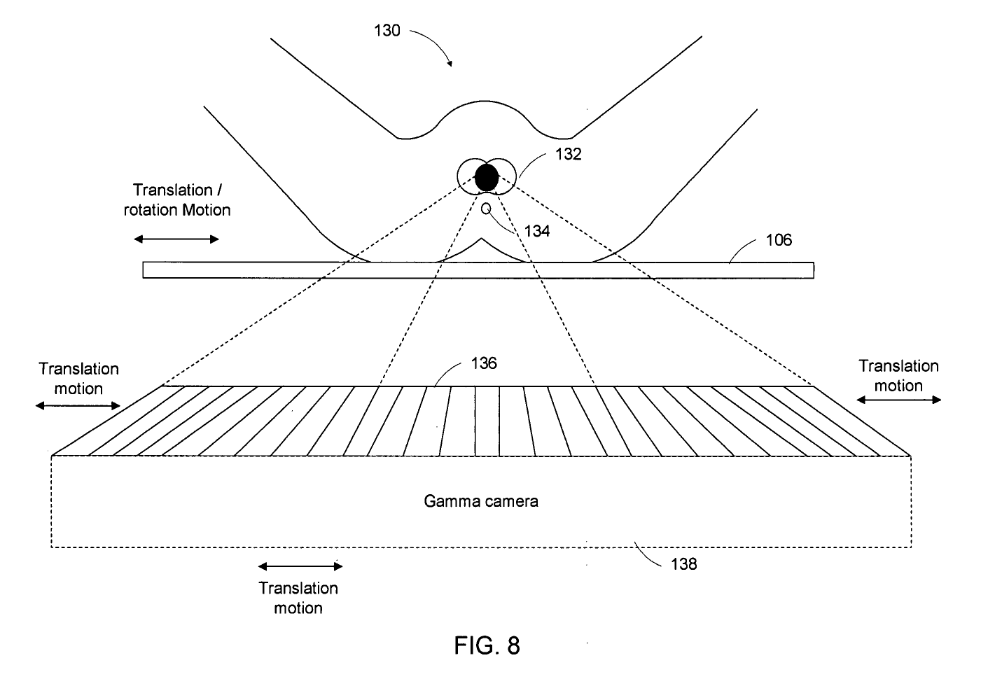

As an example of this aspect of the invention, the collimator has a finite (non-infinite) focal length. Such a collimator can be accomplished in many ways. For example, the collimator may be composed of a stack of slats. The slats are tilted non-uniformly such that imaginary extensions of the slats converge at a point—the focal point of the collimator. Collimator 136 in FIG. 8 schematically illustrates an exemplary collimator in accordance with this aspect of the invention, which will be discussed hereinafter. Other than the stacks of slats, the collimator with converging focal point may be composed of an array of holes. The holes are made and arranged such that extensions of the major axes of the holes converge at a point—the focal point.

As an aspect of the invention, the collimator is formed of a stack of slats that are dynamically movable. For example, each slat is coupled with a driving mechanism for moving (e.g. rotating) the slat. The movement can be translational or rotational or a combination thereof. In operation, the slats can be configured to have an infinite focal length by positioning the slats in parallel. When necessary, for example, in precise imaging, the slats can be configured dynamically to have the finite focal length. This can be done by moving the slats appropriately using individual driving mechanism coupled to the slats. If necessary, the slats can be dynamically adjusted to change the spatial resolution of the imaging system (also the spatial resolution of the image). This can be accomplished for varying the distance between adjacent slats of the collimator.

Regardless of whether the collimator is configured to have or not have a finite focal length, the collimator is preferably constructed in the imaging system such that the collimator, the field of interest, or the camera is capable of relative movement. As an example, the collimator is coupled to a moving mechanism, such as a motor, for moving the collimator relative to the camera or the field of interest or both. In another example, the camera can be coupled to a moving mechanism for moving the camera relative to the collimator or the field of interest or both. In yet another example, the camera and collimator can be associated together and coupled to a moving mechanism such that both of the camera and collimator are movable (e.g. together) relative to the field of interest.

Mobility of the collimator (or both of the collimator and camera) can be of great importance when the collimator has finite focal length. With the finite focal length and mobility, high spatial resolution and image acquisition efficiency can be obtained in imaging. Moreover, imaging and therapy can be performed simultaneously. This is accomplished by placing the focal point of the collimator on the field of interest and scanning the focal point across the field of interest. By combining the sequence of images taken at each location during scanning, a tomographic image of the field of interest can be reconstructed. Specifically, by lateral (or raster) motion of the camera and collimator or the collimator only, longitudinal (with limited angle) images can be acquired for the formation of a multi-plane tomographic image of the field of interest, such as prostate gland 132 and vicinity. For imaging the field of interest, such as the prostate (or any other desired body part) either by scanning the focal point over the gland or by magnification, sensitivity gain as compared to collimators composed of parallel holes can be very large. As a way of example, assuming the camera has a FOV of 12″ (30 cm) and typical size of prostate from 3 to 4 cm, the magnification can be approximately 7 to 10. Sensitivity gains relative to PHC can be approximately (7.5)² to (10)² or from 50 to 100.

Imaging speed can also be improved. For example, prostate SPECT studies normally take around 50 minutes with dual-head parallel hole collimator. The spatial resolution is approximately 2 cm. With a converging collimator as discussed above, the spatial resolution of the imaging system can be can be improved to approximately 1.3 cm or higher resolution. The imaging time can be significantly reduced to approximately 5 minutes or less, or even 1 minute or less.

An imaging system with a scanning focal point can be adapted to easily identify the position of highest tracer uptake in the prostate gland. By making small movement steps in X-Y-Z, directional gradient of the count density that representing the tracer density can be determined. The location of the “hot spots” wherein negative tumor is more likely located can be identified. Needle biopsy samples can then be taken from the identified negative regions with the highest tracer uptake.

It can also be beneficial in seed placement in brachytherapy to image either the seed or the needle used for seed placement simultaneously with the nuclear tracer image of the prostate. The prostate is deformable by a needle of ultrasonic probe. Hence, better optimization in seed placement may be possible if both seed (on needle) and radioisotope tracer are imaged simultaneously in a real-time fashion. Common isotopes capable for brachytherapy are listed in Table 1.

TABLE 1

| Isotope | Gamma ray | Abundant | HL |
|---|---|---|---|
| I-125 | 35 KeV | 0.06 | 60.1d |
| Pd-103 | 357 KeV | 0.0002 | 17d |
| | 497 KeV | 0.00004 | |

The imaging system of the invention has many advantages. For example, formation of the tomographic images do not need to be analog as required in many existing imaging systems for use in radical or nuclear medicine. Images can be reconstructed based upon statistical methods, such as maximum likelihood, maximum posterior, maximum entropy, and other suitable statistical methods.

With the high magnification and sensitivity of the system, images can be refreshed frequently during the study such that most current state of the gland subject to dynamic deformation can be obtained, and monitored in real-time.

Using a collimator composed of movable stacks of slats, the camera can acquire images in both parallel and converging focusing modes. Data acquisition in the parallel mode can facilitate comparison with conventional SPECT studies.

In another aspect of the invention, the collimator may be composed of a stack of movable slats such that the spatial resolution of the collimator can be varied. Specifically, slats of the collimator can be moved or rotated uniformly, for example, in the same direction and with the same displacement. Alternatively, the slats can be moved individually, preferably according to a predetermined pattern, such as a pattern such that a unique focal point is defined. The latter instance can be achieved by coupling each slat with a moving mechanism, such as electrostatic force with addressing electrodes or mechanical force, which will not e discussed in detail herein.

High resolution imaging with collimation angle of approximately 0.02 radians can yield system spatial resolution at 15 cm of approximately 6 mm. Such high resolution will be useful to determine if the cancer is confined to the prostate capsule or has invaded into nearby structures such as the seminal vesical. It is also noted that embodiments of the invention are also applicable to other type of cameras and can be used in examining and/or treating other organs or other parts of a human (or animal) body.

A non-transaxial single photon scanning tomographic imager using large short focal length collimation, preferably with moving slat septa can image the major arteries seen in prostate scan with high resolution. The presence of positive lymph nodes near arteries is currently is difficult. A scanner that can focus on and track arterial vessels can detect abnormal lymph nodes with higher accuracy.

FIG. 8 schematically illustrates an exemplary SPECT setup for examining and treating prostate according to an example of the invention. Patient 130 rests on pallet 106 with prostate 132 being exposed to collimator 136 and gamma camera 138. Collimator 136 is composed of a stack of slats defining a focal point with finite focal length. The patient and collimator are arranged such that the focal point of the collimator is on the prostate as shown in the figure. Gamma camera 138 is disposed underneath the patient table for imaging the prostate through the collimator by detecting the gamma rays emitted from the prostate and vicinity. The gamma rays are generated by the radiation agents injected or swallowed by the patient prior to the examination.

For imaging the prostate and vicinity, the focal point of the collimator scans different locations across the prostate and vicinity. At each location, an image is taken representing an image of the transverse layer of the prostate (or the vicinity). After the scanning, the sequence of images is reconstructed so as to form a tomographic image of the prostate and vicinity. The reconstructed tomographic image carries functional information of the prostate and vicinity and can be fused with atomic image obtained from suitable imaging systems, such as CT. The fused image can be used for guiding the treatment of the prostate when disease is found therein. In fact, imaging and treatment can be performed at the same time. For example, given a CT image, treatment actions can be taken as the functional images of the prostate being taken. Because of the efficient and short imaging time, functional images can be refreshed frequently, in the range from 20 seconds to 2 minutes during the interventional procedure. Frequent refreshing rates enable accurate treatment and real-time monitoring of the treatment, which improves treatment quality.

It will be appreciated by those skilled in the art that a new and useful radical imaging system and method of using the same have been described herein. In view of the many possible embodiments to which the principles of this invention may be applied, however, it should be recognized that the embodiments described herein with respect to the drawing figures are meant to be illustrative only and should not be taken as limiting the scope of invention. Those of skill in the art will recognize that the illustrated embodiments can be modified in arrangement and detail without departing from the spirit of the invention. Therefore, the invention as described herein contemplates all such embodiments as may come within the scope of the following claims and equivalents thereof.

What is claimed is:

1. A radical imaging system for use in radical medicine, comprising:
a radiation source for emitting radiation rays;
a camera for detecting the radiation rays;
a movable supporting mechanism on which a patient can be held; and
a stationary supporting mechanism for supporting and holding the movable first supporting mechanism,
wherein the movable supporting mechanism is capable of rotating relative to the stationary supporting mechanism along a pivoting point located within the movable supporting mechanism.

2. The system of claim 1, wherein the movable supporting mechanism is capable of rotating horizontally 180°.

3. The system of claim 2, wherein the radiation source comprises a gamma-ray emitter.

4. The system of claim 3, wherein the camera comprises a gamma camera that is located on the opposite side of the movable supporting mechanism relative to the radiation source.

5. The system of claim 1, further comprising:
a foot resting mechanism on which patient's feet can be placed, wherein the foot resting mechanism is capable of moving relative to the movable supporting mechanism.

6. The system of claim 5, wherein the foot resting mechanism is attached to the movable supporting mechanism.

7. The system of claim 1, wherein the camera is coupled to a camera rotating mechanism such that the camera is capable of rotating to a position substantially on a plane of the movable supporting mechanism.

8. The system of claim 7, wherein the camera is capable of rotating to a position between the legs of the patient.

9. The system of claim 1, further comprising:
a x-ray radiation source; and
a x-ray camera for detecting the x-ray from the x-ray source,
wherein the x-ray source and x-ray camera are displaced such that the x-ray passes through the patient's body.

10. A method for examining a patient, comprising:
placing the patient on a patient table and aligning the patient with a first examination axis;
imaging the patient with a radical imaging system;
aligning the patient with a second examination axis that is substantially perpendicular to the first examination axis; and
imaging the patient with the radiation imaging system.

11. The method of claim 10, wherein the step of aligning the patient with the second examination axis further comprises:
rotating the patient table along a stationary pivoting point that is located within the patient table, wherein the stationary pivoting point does not move with the rotation of the patient table.

12. The method of claim 10, further comprising:
moving the camera to a position that is substantially on a plane of the patient table and is substantially between the legs of the patient.

13. The method of claim 10, wherein the imaging system comprises a radical source capable of generating radical rays.

14. The method of claim 13, wherein the radiation source comprises a positron, and wherein the camera comprises a gamma camera.

15. The method of claim 14, wherein the gamma camera and radiation source are placed such that radiation ray passes through the patient's body before being detected by the camera.

16. The method of claim 14, wherein the camera is placed under the patient table.

17. A radical examining system for use in radical medicine, the method comprising:
a radical source for generating a radical ray;
a camera for detecting the radical ray from the radical source;
a patient table on which a patient can be placed;
a collimator comprising a set of structures that together define a non-infinite focal point; and
a driving mechanism coupled to the collimator, patient table, or the camera for causing the focal point of the collimator to move relative to the patient table.

18. The system of claim 17, wherein the set of structures comprises a stack of slats at least two of which are not parallel to each other.

19. The system of claim 17, wherein the set of structures comprises a set of holes at least two of which are not parallel to each other.

20. The system of claim 17, wherein the driving mechanism is coupled to at least one of the collimator, patient body, and camera.

21. The system of claim 20, wherein the driving mechanism is coupled to the collimator for moving the collimator.

22. The system of claim 21, wherein the driving mechanism is coupled to the collimator in such a way that the collimator is capable of performing translation movement in the X-Y, Z-Y, and X-Z, wherein X-Y is the plane of the patient's table.

23. The system of claim 22, wherein the driving mechanism is coupled to the collimator such that the collimator is capable of moving three dimensionally.

24. The system of claim 17, wherein the driving mechanism is coupled to the camera such that the camera is capable of performing translation movement in the X-Y, Z-Y, and X-Z, wherein X-Y is the plane of the patient's table.

25. The system of claim 24, wherein the driving mechanism is coupled to the camera such that the camera is capable of moving three dimensionally.

26. The system of claim 17, wherein the driving mechanism is coupled to both of the camera and collimator such that the collimator and camera can be moved together.

27. The system of claim 17, wherein the driving mechanism is coupled to the patient table for moving the patient table relative to the camera.

28. The system of claim 17, wherein the driving mechanism is coupled to the patient table for moving the patient table relative to the collimator.

29. The system of claim 17, wherein the camera is placed underneath the patient table.

30. The system of claim 17, wherein the radiation source comprises positron, and wherein the camera comprises a gamma camera.

31. The system of claim 17, further comprising:
a statistical module for performing statistical iterative reconstruction for modeling the collimator.

32. The system of claim 17, wherein the collimator is coupled with a dynamic crossed “venetian blind” for allowing XYZ scanning of the focal point of the collimator to be implemented with internal motion of collimator components only.

33. The system of claim 17 is portion of a multi-modality imaging system that further comprises a different modality.

34. The system of claim 33, wherein the different modality comprises at least one of a CT, MRI, and an US imaging system.

35. The system of 17, wherein the patient table is coupled to a moving mechanism such that the patient table is capable of rotating along a stationary pivoting point located within the patient table.

36. The system of claim 35, wherein the patient table is coupled with the moving mechanism such that the patient table is substantially not capable of performing translation movement.

37. The system of claim 35, wherein the patient table is coupled to the moving mechanism such that the patient table is capable of moving from a first position to a second position that is substantially 90° from the second position.

38. The system of claim 37, further comprising:
a pair of feet resting saddles for holding patient's feet.

39. The system of claim 38, wherein the feet saddles are capable of moving relative to the patient's table.

40. A method of performing radical medicine, comprising:
placing a patient in a radical imaging system; and
imaging a field of the patient using the radical system and medically treating the field based on the image substantially simultaneously with imaging.

41. The method of claim 40, wherein the step of imaging comprises:
aligning a focal point of a collimator on the field, wherein the collimator directs radiation ray between a radical source and camera of the imaging system; and
scanning the focal point on the field so as to obtain a tomographic image of the field.

42. The method of claim 41, wherein the step of scanning the focal point comprises:
moving the collimator relative to the camera and the field.

43. The method of claim 42, wherein the step of scanning the focal point comprises:
moving the camera relative to the collimator and patient table.

44. The method of claim 42, wherein the step of scanning the focal point comprises:
moving the collimator and camera together relative to the patient table.

45. The method of claim 42, wherein the radical source comprises a gamma-emitter in the field, wherein the camera comprises a gamma camera.

46. The method of claim 42, wherein the camera is placed under the patient table.

47. The method of claim 42, wherein the collimator comprises a stack of slats arranged in such a way as to define the focal point.

48. The method of claim 42, wherein the collimator comprises a set of holes at least two of which are not parallel to each other.

49. The method of claim 41, wherein the step of imaging the field further comprises a step of obtaining an anatomic image and a functional image of the field.

50. The method of claim 49, wherein the anatomic image of the field is obtained using a CT imaging system.

51. The method of claim 42, further comprising:
imaging the field as the action is taken on the field.

52. The method of claim 42, further comprising:
imaging the field periodically with periods ranging from tens of seconds to several minutes during the step of acting on the field.

53. The method of claim 41, further comprising:
adjusting a focal point of the collimator by moving a set of movable slats of the collimator.

54. The method of claim 41, further comprising:
adjusting the spatial resolution of the collimator by moving a set of movable slats of the collimator.

55. A radical image for use in radical medicine, comprising:
a radical source for generating a beam of radiation ray;
a camera for generating an image using the radiation beam; and
a collimator composed of a stack of movable slats.

56. An imaging method, comprising:
aligning a radical source, target object, and camera such that a radiation beam from the radical source is capable of being detected by the camera after passing through the target object;
placing a collimator between the target object and camera, wherein said collimator comprises a stack of movable slats;
adjusting the slats such that the collimator has a non-infinite focal point; and
imaging the target object by scanning the focal point on the target object.

57. The method of claim 56, further comprising:
adjusting the slats such that the collimator has an infinite focal point; and
imaging the target object.

58. The method of claim 56, further comprising:
configuring the collimator to a first state by moving the slats such that the image taken for the target object has a first spatial resolution;
imaging the target object with the first resolution;
configuring the collimator to a second state other than the first state by moving the slats such that the image taken for the target object has a second spatial resolution different from the first resolution; and
imaging the target object with the second resolution.
